(19) United States
(12) Patent Application Publication
(10) Pub. No.: US 2017/0164599 A1
(43) Pub. Date: Jun. 15, 2017

(54) SPRAYING DEVICE AND BOOM DAMPING DEVICE

(71) Applicant: KYB Corporation, Tokyo (JP)

(72) Inventors: Tatsuo ITO, Kanagawa (JP); Takanori INADA, Tokyo (JP); Takanobu YOSHIDA, Saitama (JP); Tomomichi MIZUKAMI, Saitama (JP); Atsushi OOTA, Iwate (JP); Masaki AKASHI, Chiba (JP); Yasuo TANAKA, Saitama (JP); Hiroki TOKUDA, Tokyo (JP)

(73) Assignee: KYB Corporation, Tokyo (JP)

(21) Appl. No.: 15/118,109

(22) PCT Filed: Oct. 17, 2014
(86) PCT No.: PCT/JP2014/077756

§ 371 Date: Aug. 11, 2016

(30) Foreign Application Priority Data
Feb. 19, 2014 (JP) 2014-029482

(51) Int. Cl. A01M 7/00; B05B 13/00; A01G 25/09

(52) U.S. Cl. CPC A01M 7/0053; A01G 25/09; B05B 13/005

(57) ABSTRACT

A boom damping device includes a fluid pressure cylinder configured to perform an expansion/contraction operation in conjunction with rotational movement of a boom in a roll direction of a working vehicle, a first pressure accumulator into/out of which an operating fluid flows through a first passage with the expansion/contraction operation of the fluid pressure cylinder, a second pressure accumulator into/out of which the operating fluid flows through a second passage with the expansion/contraction operation of the fluid pressure cylinder, and a shut-off switch configured to shut off the first passage and configured to shut off the second passage if at least either one of a right boom and a left boom is not at a working position expanded in a right-and-left direction of the working vehicle.

### TECHNICAL FIELD

The present invention relates to a spraying device and a boom damping device.

### BACKGROUND ART

JP2005-13935A discloses a boom sprayer for spraying a control liquid (agricultural chemicals). This boom sprayer includes a boom supporting member provided on a front part of a working vehicle and right and left booms supported by the boom supporting member in a cantilever manner and extending in a right-and-left direction of a vehicle body. Moreover, the boom supporting member is rotatable in a rolling direction of the vehicle body, and the boom sprayer controls a rolling attitude of the boom which is an inclination attitude to right and left by a horizontal cylinder.

### SUMMARY OF INVENTION

In the aforementioned boom sprayer, since the right and left booms are supported by the boom supporting member in the cantilever manner, if only one of the booms is folded, the boom supporting member is rotationally moved in the rolling direction of the vehicle body by a weight of the other boom. If the boom supporting member is rotationally moved, it is likely that a tip end of the other boom lowers and touches the ground.

An object of the present invention is to provide a spraying device and a boom damping device capable of preventing contact of the boom with the ground when the right and left weight balance of the boom is lost.

According to one aspect of the present invention, a boom damping device for suppressing vibration of a boom capable of rotational movement in a roll direction of a working vehicle, the boom having a right boom expanded in a right direction of the working vehicle and a left boom expanded in a left direction of the working vehicle is provided. The boom damping device includes: a fluid pressure cylinder connected between the working vehicle and the boom, the fluid pressure cylinder being configured to perform an expansion/contraction operation in conjunction with rotational movement of the boom in the roll direction of the working vehicle; a first pressure accumulator configured to pressurize one chamber of the fluid pressure cylinder and into/out of which an operating fluid flows through a first passage with the expansion/contraction operation of the fluid pressure cylinder; a second pressure accumulator configured to pressurize the other chamber of the fluid pressure cylinder and into/out of which the operating fluid flows through a second passage with the expansion/contraction operation of the fluid pressure cylinder; and a shut-off switch configured to shut off the first passage and configured to shut off the second passage if at least either one of the right boom and the left boom is not at a working position expanded in a right-and-left direction of the working vehicle.

### BRIEF DESCRIPTION OF DRAWINGS

FIG. 1 is a plan view of a working vehicle on which a spraying device according to an embodiment of the present invention is mounted.

FIG. 2 is a side view of the working vehicle on which the spraying device according to the embodiment of the present invention is mounted.

FIG. 3 is a perspective view of the spraying device according to the embodiment of the present invention.

FIG. 4 is a configuration diagram of a boom damping device according to the embodiment of the present invention.

FIG. 5A is an enlarged view illustrating a connection spot between a roll base and a left boom in an enlarged manner.

FIG. 5B is an enlarged view illustrating a connection spot between the roll base and the left boom in an enlarged manner.

### DESCRIPTION OF EMBODIMENT

An embodiment of the present invention will be described below by referring to the attached drawings.

For convenience of explanation, three axes, that is, X, Y, and Z orthogonal to each other on the attached drawings are set. The X-axis is an axis extending in a longitudinal direction of a vehicle (substantially horizontally vertical direction), the Y-axis is an axis extending in a right-and-left direction of the vehicle (substantially horizontally lateral direction), and the Z-axis is an axis extending in an up-and-down direction of the vehicle (substantially vertical direction). Moreover, a rotating direction around the X-axis is referred to as a roll direction, and a rotating direction around the Z-axis is referred to as a yaw direction.

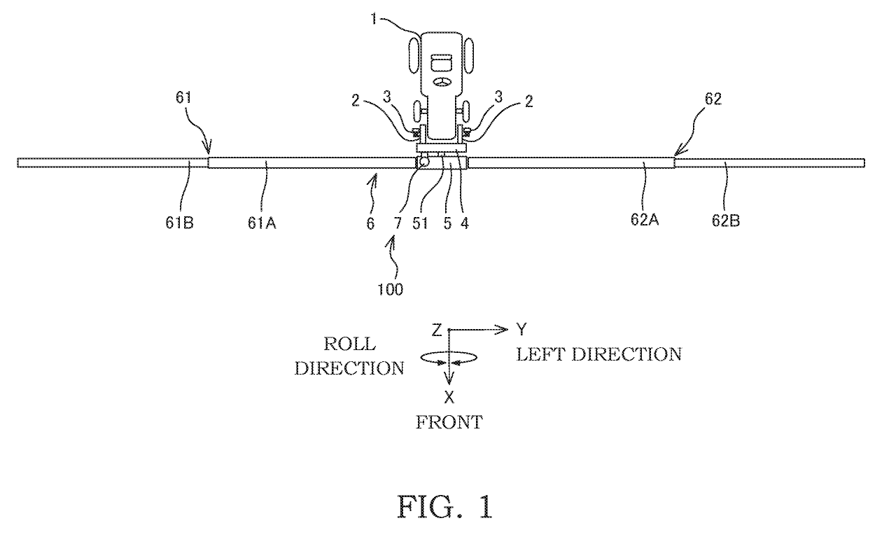

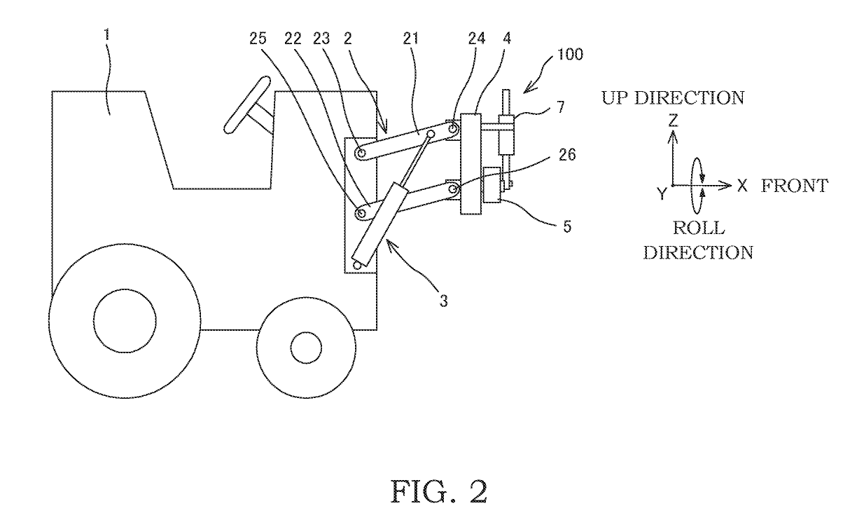

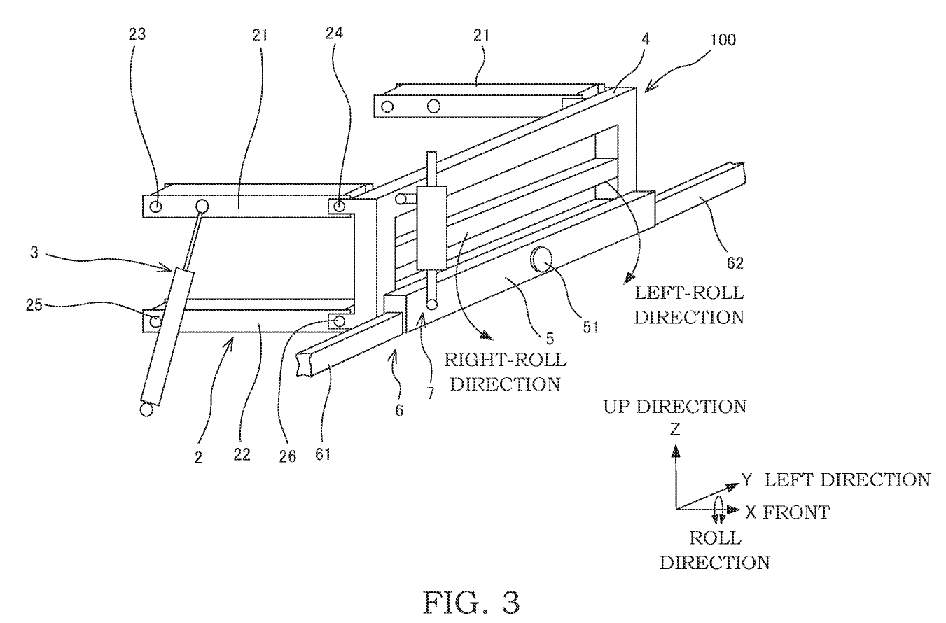

FIG. 1 is a plan view of a working vehicle 1 on which a spraying device 100 in this embodiment is mounted. FIG. 2 is a side view of the working vehicle 1 on which the spraying device 100 in this embodiment is mounted and illustrates a state in which the working vehicle 1 in FIG. 1 is seen from the Y-axis direction. FIG. 3 is a perspective view of the spraying device 100 mounted on the working vehicle 1.

The spraying device 100 is an agricultural device mounted on a front side of the working vehicle 1 such as a tractor running on a farm field and spraying a control liquid (agricultural chemicals) from the working vehicle 1.

The spraying device 100 includes a link arm 2 mounted on a front of the working vehicle 1, an elevation cylinder 3 for elevating the link arm 2 up/down, an elevation base 4 supported by the link arm 2, capable of elevation up/down with respect to the working vehicle 1, a roll base 5 supported rotatably in the roll direction with respect to the elevation base 4, and a boom 6 extending in the right-and-left direction (Y-axis direction) of the working vehicle 1 from the roll base 5.

The link arm 2 is a link mechanism composed of an upper link 21 and a lower link 22 provided in a pair on right and left of the working vehicle 1. The upper link 21 and the lower link 22 extend in parallel with each other and are arranged so as to be a parallelogram when seen from a side face (FIG. 2).

The upper link 21 has a base end portion connected rotatably to the working vehicle 1 through a pin 23 and a tip end portion rotatably connected to the elevation base 4 through a pin 24. The lower link 22 has a base end portion connected rotatably to the working vehicle 1 through a pin 25 and a tip end portion connected rotatably to the elevation base 4 through a pin 26.

The link arm 2 supports the elevation base 4 capable of elevation up/down but instead of this, by providing a guide rail extending in the Z-axis direction on the front part of the working vehicle 1, the elevation base 4 may be supported capable of elevation up/down by this guide rail.

The elevation cylinders 3 are provided in a pair on right and left of the working vehicle 1. Each of the elevation cylinders 3 is interposed between the working vehicle 1 and the upper link 21 and is expanded/contracted in accordance with supply/discharge of working oil. When the elevation cylinder 3 is extended, the link arm 2 is rotationally moved upward, and the elevation base 4 and the boom 6 are raised. When the elevation cylinder 3 is contracted, the link arm 2 is rotationally moved downward, and the elevation base 4 and the boom 6 are lowered.

The elevation base 4 is connected to tip ends of the upper link 21 and the lower link 22 through the pins 24 and 26 and is moved in a vertical direction in accordance with rising and lowering of the link arm 2.

The roll base 5 is provided in front of the elevation base 4 and is supported rotatably on the elevation base 4 through a support shaft 51 (FIG. 3). The roll base 5 is rotatable in the roll direction with respect to the elevation base 4 around the support shaft 51 and constitutes a center boom supporting left and right booms 61 and 62. The support shaft 51 is a columnar pin but this is not limiting and a spherical bearing or the like may be used.

The boom 6 has a right boom 61 that can be expanded to a right direction of the working vehicle 1 and a left boom 62 that can be expanded to a left direction of the working vehicle 1. The right boom 61 and the left boom 62 are supported on the roll base 5 in the cantilever manner, respectively. That is, the right boom 61 and the left boom 62 have their respective base end portions supported on the roll base 5 rotatably in the yaw direction around a rotating shaft in the cantilever manner, and tip end portions are free ends. The rotating shaft will be described later.

The right boom 61 has a base-end side frame 61A having a base end portion and a tip-end side frame 61B supported on a tip end side of the base-end side frame 61A, capable of expansion/contraction, and having a tip end portion. The left boom 62 has a base-end side frame 62A having a base end portion and a tip-end side frame 62B supported on a tip end side of the base-end side frame 62A, capable of expansion/contraction, and having a tip end portion (FIG. 1).

On the boom 6, a nozzle (not shown) for spraying the control liquid is mounted. During a work of the spraying device 100, the control liquid is sprayed from the nozzle of the boom 6 of the spraying device 100 while the working vehicle 1 is running on the farm field.

The right boom 61 and the left boom 62 extend in the right-and-left direction of the working vehicle 1 when in the expanded state illustrated in FIG. 1. If they are in this expanded state, this is assumed that the boom 6 is at a working position. When the boom 6 is to be stored, the tip-end side frames 61B and 62B are made to slide to sides of the base-end side frames 61A and 62A so as to contract the boom 6 and then, the boom 6 is rotationally moved rearward around the rotating shaft. As a result, the boom 6 is folded so as to extend in a longitudinal direction along the side of the working vehicle 1.

The spraying device 100 further includes a boom damping device 7 provided between the elevation base 4 and the roll base 5 and suppressing vibration of the boom 6 in the roll direction.

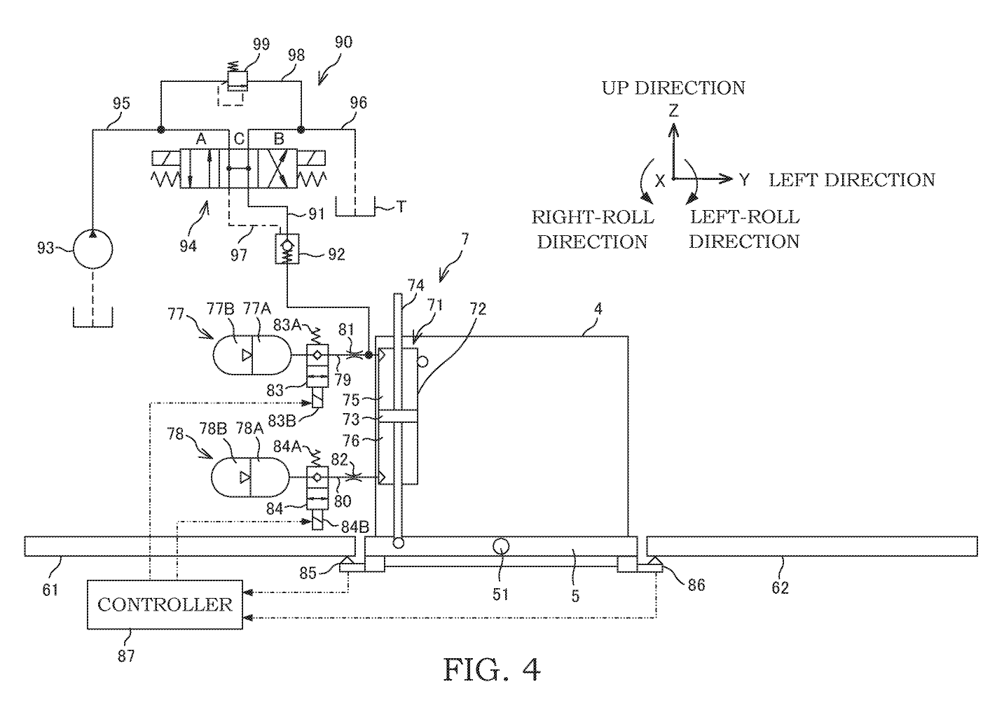

FIG. 4 is a configuration diagram of the boom damping device 7 in this embodiment. In the explanation below, a right rotating direction around the X-axis when the working vehicle 1 is seen from an operator is referred to as a right roll direction and a left rotating direction as a left roll direction.

The boom damping device 7 includes a single hydraulic cylinder 71 expanded/contracted in conjunction with rotational movement of the boom 6 in the right and left roll directions.

The hydraulic cylinder 71 as a fluid pressure cylinder has a cylinder tube 72 in which the operating oil is sealed and a piston rod 74 connected to both ends of a piston 73 slidably inserted into the cylinder tube 72. An inside of the cylinder tube 72 is divided by the piston 73 into a first chamber 75 as one chamber arranged in an upper part and a second chamber 76 as the other chamber arranged in a lower part.

The hydraulic cylinder 71 uses the operating oil as an operating fluid but may use an operating liquid such as a water-soluble substitute liquid or the like, for example, instead of the operating oil or may use a gas.

The cylinder tube 72 is rotatably connected to the elevation base 4. A lower end portion of the piston rod 74 is rotatably connected to the roll base 5. That is, the cylinder tube 72 is connected to the working vehicle 1 through the elevation base 4, and the piston rod 74 is connected to the boom 6 through the roll base 5. As a result, when the boom 6 is rotationally moved in the roll direction, the hydraulic cylinder 71 is expanded/contracted.

A constitution is not limited to that described above but may be such that an upper end portion of the piston rod 74 is connected to the working vehicle 1 through the elevation base 4, and the cylinder tube 72 is connected to the boom 6 through the roll base 5.

The boom damping device 7 further includes a first accumulator 77 as a first pressure accumulator for pressurizing the first chamber 75 of the hydraulic cylinder 71, a second accumulator 78 as a second pressure accumulator for pressurizing the second chamber 76 of the hydraulic cylinder 71, a first passage 79 for connecting the first accumulator 77 and the first chamber 75, a second passage 80 for connecting the second accumulator 78 and the second chamber 76, a first damping valve 81 for giving resistance to a flow of the operating oil passing through the first passage 79, and a second damping valve 82 for giving resistance to the flow of the operating oil passing through the second passage 80.

The first accumulator 77 has an oil chamber 77A communicating with the first passage 79 and a pressure accumulation chamber 77B for accumulating a compressed gas for pressurizing the oil chamber 77A. When the boom 6 is rotationally moved in the roll direction, the hydraulic cylinder 71 is expanded/contracted, and the operating oil flows into/out of the first accumulator 77 through the first passage 79.

The second accumulator 78 has an oil chamber 78A communicating with the second passage 80 and a pressure accumulation chamber 78B for accumulating a compressed gas for pressurizing the oil chamber 78A. When the boom 6 is rotationally moved in the roll direction, the hydraulic cylinder 71 is expanded/contracted and the operating oil flows into/out of the second accumulator 78 through the second passage 80.

In contraction of the hydraulic cylinder 71 when the boom 6 is rotationally moved in the left roll direction, the operating oil in the contracted first chamber 75 flows into the first accumulator 77 and the operating oil in the second accumulator 78 flows into the expanding second chamber 76.

On the contrary, in expansion of the hydraulic cylinder 71 when the boom 6 is rotationally moved in the right roll direction, the operating oil from the first accumulator 77 flows into the expanding first chamber 75 and the operating oil in the contracting second chamber 76 flows into the second accumulator 78.

As described above, with rotational movement of the boom 6 in the right roll direction and the left roll direction, the operating oil in the same volume is supplied to/discharged from the first accumulator 77 and the second accumulator 78. As a result, a pressure difference is generated between the pressure accumulation chamber 77B of the first accumulator 77 and the pressure accumulation chamber 78B of the second accumulator 78. The boom 6 is held at a position where an urging force urged in the right roll direction by a gas pressure of the first accumulator 77 is balanced with the urging force urged in the left roll direction by the gas pressure of the second accumulator 78.

The hydraulic cylinder 71 is a double rod type in which the piston rod 74 protrudes from both ends of the cylinder tube 72. As a result, when the hydraulic cylinder 71 expands/contracts, a flow rate of the operating oil moving through the first passage 79 becomes equal to a flow rate of the operating oil moving through the second passage 80, and a variation of the gas pressure of the first accumulator 77 becomes equal to a variation of the gas pressure of the second accumulator 78.

The first damping valve 81 gives resistance to the operating oil passing through the first passage 79 with expansion/contraction of the hydraulic cylinder 71, whereby a damping force for suppressing vibration of the boom 6 in the roll direction is generated.

The second damping valve 82 gives resistance to the operating oil passing through the second passage 80 with expansion/contraction of the hydraulic cylinder 71, whereby a damping force for suppressing vibration of the boom 6 in the roll direction is generated.

That is, the first damping valve 81 and the second damping valve 82 function as roll dampers for suppressing vibration of the boom 6 in the roll direction. The first damping valve 81 and the second damping valve 82 may be fixed apertures or may be variable apertures whose opening areas increase in accordance with an increase in a flow velocity of the passing operating oil. Moreover, instead of the first damping valve 81 and the second damping valve 82, a fixed aperture such as an orifice may be interposed and constituted so that its aperture channel area or aperture channel length can be manually adjusted.

The boom damping device 7 further includes a first shut-off valve 83 as a shut-off switch interposed in the first passage 79, a second shut-off valve 84 as a shut-off switch interposed in the second passage 80, a right-boom sensor 85 as a right-boom detector for detecting an extended state of the right boom 61, a left-boom sensor 86 as a left-boom detector for detecting an extended state of the left boom 62, and a controller 87 as a control part for controlling the first shut-off valve 83 and the second shut-off valve 84.

The first shut-off valve 83 is a shut-off valve capable of being switched between a communication position where the first passage 79 is allowed to communicate and a shut-off position where the first passage 79 is shut off. At the shut-off position, the first passage 79 is not completely closed, but only the flow of the operating oil from the first accumulator 77 toward the first chamber 75 is allowed.

The second shut-off valve 84 is a shut-off valve capable of being switched between a communication position where the second passage 80 is allowed to communicate and a shut-off position where the second passage 80 is shut off. At the shut-off position, only the flow of the operating oil from the second accumulator 78 toward the second chamber 76 is allowed.

The first shut-off valve 83 and the second shut-off valve 84 are held at the shut-off positions by the urging forces of springs 83A and 84A and are switched to the communication positions when solenoids 83B and 84B are excited on the basis of a driving signal supplied from the controller 87.

The first shut-off valve 83 and the second shut-off valve 84 are subjected to switching control in conjunction so that the both are switched to the same switching position. Therefore, when the first shut-off valve 83 and the second shut-off valve 84 are switched to the shut-off positions, the operating oil in the first chamber 75 and the second chamber 76 cannot flow either to the first accumulator 77 or the second accumulator 78 and thus, the first passage 79 is substantially shut off, and the second passage 80 is substantially shut off.

The right-boom sensor 85 detects whether or not the right boom 61 has been extended to be arranged on an extension of the roll base 5 and is located at a working position extending in the right-and-left direction of the working vehicle 1 and transmits a detection result to the controller 87. Even if the tip-end side frame 61B is made to slide to the base-end side frame 61A side so as to contract the right boom 61, if the right boom 61 extends in the right-and-left direction of the working vehicle 1, it is detected that the right boom 61 is at the working position.

The left-boom sensor 86 detects whether or not the left boom 62 has been extended to be arranged on an extension of the roll base 5 and is located at a working position extending in the right-and-left direction of the working vehicle 1 and transmits a detection result to the controller 87. Even if the tip-end side frame 62B is made to slide to the base-end side frame 62A side so as to contract the left boom 62, if the left boom 62 extends in the right-and-left direction of the working vehicle 1, it is detected that the left boom 62 is at the working position.

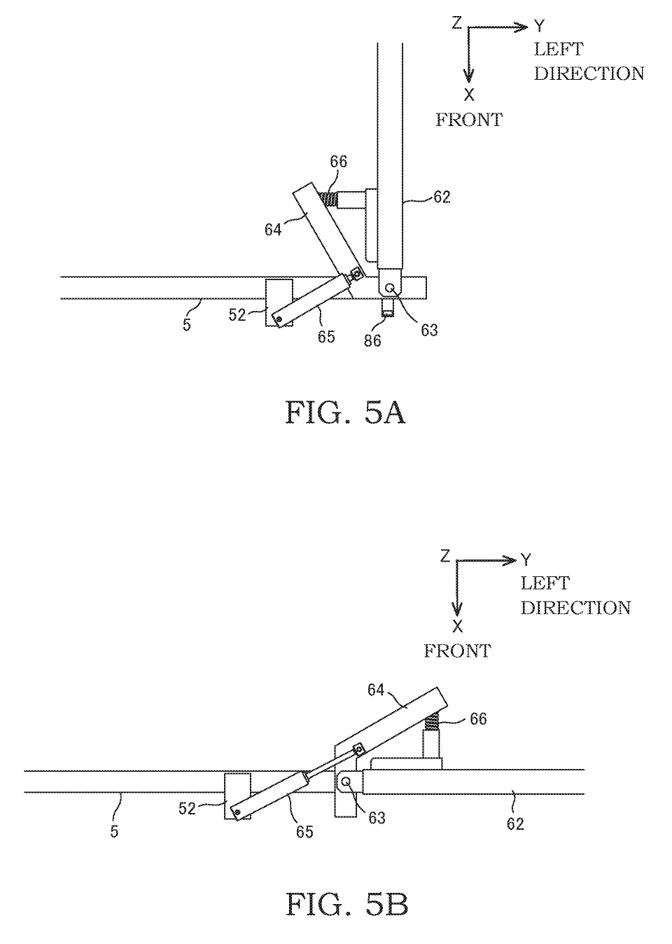

Here, an operation of the left boom sensor 86 will be described by referring to FIGS. 5A and 5B.

FIGS. 5A and 5B are enlarged views illustrating a connection spot between the roll base 5 and the left boom 62 in an enlarged manner.

As illustrated in FIG. 5A, on an end portion of the roll base 5, a pin 63 as the aforementioned rotating shaft pivotally and rotatably supporting the left boom 62, a roll-base side bracket 52 extending to the front from the roll base 5, a substantially L-shaped boom-side bracket 64 with one end side pivotally supported by the pin 63 together with the left boom 62, a hydraulic cylinder 65 connected between the roll-base side bracket 52 and the boom-side bracket 64, a spring 66 connected between the other end side of the boom-side bracket 64 and the left boom 62, and the left-boom sensor 86 extending to the front from the vicinity of the pin 63 of the roll-base 5 are provided. Expansion/contraction of the hydraulic cylinder 65 is performed in accordance with a lever operation by the operator or the like.

FIG. 5A illustrates a state in which the left boom 62 is folded so as to extend in a longitudinal direction along the side of the working vehicle 1. By expanding the hydraulic cylinder 65 in this state, the boom-side bracket 64 is rotationally moved clockwise in FIG. 5A around the pin 63. With that, the left boom 62 is pressed by the boom-side bracket 64 through the spring 66 and is rotationally moved.

FIG. 5B illustrates a state in which the left boom 62 is extended so as to extend in a right-and-left horizontal direction of the working vehicle 1. When the left boom 62 is extended to the working position by expansion of the hydraulic cylinder 65, the one end side of the boom-side bracket 64 from the pin 63 is brought into contact with the left-boom sensor 86. As a result, the left-boom sensor 86 is turned ON, and a detection signal is transmitted to the controller 87.

Since the spring 66 is interposed between the boom-side bracket 64 and the left boom 62, even if the left boom 62 touches an obstacle during working in a state in which the left boom 62 is completely extended, an impact can be absorbed by contraction of the spring 66.

When the hydraulic cylinder 65 is contracted and the left boom 62 is folded, and when the boom-side bracket 64 is separated away from the left-boom sensor 86, the left-boom sensor 86 is turned OFF, and a detection signal is transmitted to the controller 87.

The left-boom sensor 86 has been described above, and since the same applies to the right-boom sensor 85, the explanation will be omitted.

Returning to FIG. 4, the controller 87 subjects the first shut-off valve 83 and the second shut-off valve 84 to switching control on the basis of the detection signals of the right-boom sensor 85 and the left-boom sensor 86. If at least either one of the right-boom sensor 85 and the left-boom sensor 86 is in the OFF state, the controller 87 switches the first shut-off valve 83 and the second shut-off valve 84 to the shut-off position, and only if the right-boom sensors 85 and the left-boom sensor 86 are both in the ON state, the controller 87 switches the first shut-off valve 83 and the second shut-off valve 84 to the communication position.

As a result, if at least either one of the right boom 61 and the left boom 62 is folded, the first shut-off valve 83 and the second shut-off valve 84 are switched to the shut-off position and thus, expansion/contraction of the hydraulic cylinder 71 is regulated. Thus, even if the right-and-left weight balance of the boom 6 is lost, the roll base 5 is prevented from rotating, and breakage of the boom 6 caused by rotation of the roll base 5 is prevented.

Moreover, if both the right boom 61 and the left boom 62 are extended, the first shut-off valve 83 and the second shut-off valve 84 are switched to the communication position and thus, the first damping valve 81 and the second damping valve 82 give resistance to the flow of the operating oil in the first passage 79 and the second passage 80, whereby vibration of the boom 6 in the roll direction is suppressed.

The boom damping device 7 further includes an operating-oil supply/discharge mechanism 90 for supplying/discharging the operating oil to/from the hydraulic cylinder 71. The operating-oil supplying/discharging mechanism 90 expands/contracts the hydraulic cylinder 71 by supplying/discharging the operating oil to/from the hydraulic cylinder 71 and adjusts a roll angle of the boom 6 so that the boom 6 is held in the horizontal direction. If the working vehicle 1 is inclined on an inclined land or the like, the operating-oil supplying/discharging mechanism 90 adjusts the roll angle of the boom 6 so that the boom 6 is held not horizontally but at a desired angle along the inclination.

The operating-oil supplying/discharging mechanism 90 includes a supply/discharge passage 91 communicating with the first chamber 75 of the hydraulic cylinder 71, an operate check valve 92 interposed in the supply/discharge passage 91, and a directional switching valve 94 for switching communication of a hydraulic pump 93 and a tank T with respect to the supply/discharge passage 91.

To the directional switching valve 94, a supply passage 95 for leading the operating oil discharged from the hydraulic pump 93, a discharge passage 96 for returning the operating oil to the tank T, an operate passage 97 communicating with a pilot pressure chamber of the operate check valve 92, and the supply/discharge passage 91 communicating with the first chamber 75 are connected. Moreover, in a relief passage 98 connecting the supply passage 95 and the discharge passage 96, a relief valve 99 for opening the valve when a hydraulic pressure of the supply passage 95 exceeds a set pressure is provided.

The directional switching valve 94 has a left roll position A, a right roll position B, and a neutral position C and is switched to any one of the positions so that the boom 6 is held horizontally or at the desired angle along inclination of the farm field.

When the directional switching valve 94 is switched to the left roll position A, the supply passage 95 and the operate passage 97 are allowed to communicate and the supply/discharge passage 91 and the discharge passage 96 are allowed to communicate. A discharge pressure of the hydraulic pump 93 is led as a pilot pressure to the operate check valve 92 through the operate passage 97 and thus, the operate check valve 92 is opened, and the operating oil in the first chamber 75 is returned to the tank T through the supply/discharge passage 91 and the discharge passage 96. As a result, the piston 73 of the hydraulic cylinder 71 is moved upward in FIG. 4, and the boom 6 is rotationally moved in the left roll direction.

When the directional switching valve 94 is switched to the right roll position B, the discharge passage 96 and the operate passage 97 are allowed to communicate, and the supply/discharge passage 91 and the supply passage 95 are allowed to communicate. The operating oil discharged from the hydraulic pump 93 flows into the first chamber 75 through the supply passage 95 and the supply/discharge passage 91. As a result, the piston 73 of the hydraulic cylinder 71 is moved downward in FIG. 4, and the boom 6 is rotationally moved in the right roll direction.

When the directional switching valve 94 is switched to the neutral roll position C, the supply passage 95, the discharge passage 96, the operate passage 97, and the supply/discharge passage 91 are allowed to communicate, respectively, and the operating oil is returned to the tank T. As a result, the operating oil flowing into/out of the first chamber 75 through the supply/discharge passage 91 is shut off, and the operate check valve 92 is closed. Thus, movement of the piston 73 in the hydraulic cylinder 71 is stopped, and rotational movement of the boom 6 is stopped.

The controller 87 drives a solenoid of the directional switching valve 94 so that the boom 6 is held at the desired angle on the basis of an operation instruction of the operator. As a result, the boom 6 is rotationally moved in the right and left roll directions, and the roll angle of the boom 6 is adjusted, whereby the boom 6 can be held at the desired angle at all times regardless of an attitude change of the working vehicle 1. The operating-oil supplying/discharging mechanism 90 is not limited to the constitution in which the operating oil is supplied/discharged with respect to the first chamber 75 of the hydraulic cylinder 71 so as to rotationally move the boom 6 in the roll direction but may be constituted such that the operating oil is supplied/discharged with respect to the second chamber 76 so as to rotationally move the boom 6 in the roll direction.

The working vehicle 1 sprays the control liquid from the nozzle of the boom 6 in the spraying device 100, while running on a farm field in the work. At this time, the left and right booms 61 and 62 are centered at the positions where the gas pressures of the pressure accumulation chambers 77B and 78B of the first accumulator 77 and the second accumulator 78 are balanced in accordance with a stroke of the hydraulic cylinder 71.

For example, if the working vehicle 1 runs by riding over irregularity of the farm field and if the attitude of the working vehicle 1 is changed in the roll direction, a force to rotationally move the boom 6 in the roll direction acts on the roll base 5 through the hydraulic cylinder 71. At this time, since the boom 6 is to stay at that place by an inertia force, the hydraulic cylinder 71 is expanded/contracted by the inertia force of the boom 6 and absorbs inclination of the working vehicle 1.

If the hydraulic cylinder 71 cannot fully absorb the inclination of the working vehicle 1 and if a force caused by the gas pressure difference between the pressure accumulation chambers 77B and 78B of the first accumulator 77 and the second accumulator 78 exceeds the inertia force of the boom 6, the boom 6 begins to roll. However, the roll vibration is rapidly damped by the first damping valve 81 and the second damping valve 82. In this way, since the change in the force acting on the roll base 5 from the working vehicle 1 is absorbed by expansion/contraction of the hydraulic cylinder 71, large rotational movement of the boom 6 in the roll direction is suppressed, and collision of the tip end portion of the boom 6 against the farm field or the like is prevented.

Moreover, with the expansion/contraction of the hydraulic cylinder 71, the first damping valve 81 and the second damping valve 82 give resistance to the flow of the operating oil flowing into/out of the first accumulator 77 and the second accumulator 78 and thus, vibration of the boom 6 in the roll direction can be suppressed. As a result, the control liquid injected from the nozzle of the boom 6 can be uniformly sprayed.

According to the aforementioned embodiment, the following effects can be exerted.

If at least either one of the right boom 61 and the left boom 62 is folded, the first passage 79 is shut off, and the second passage 80 is also shut off and thus, an expansion/contraction operation of the hydraulic cylinder 71 can be stopped. Thus, even if right and left weight balance of the boom 6 is lost, rotational movement of the boom 6 can be braked, and thus, lowering of the extended boom 6 and contact thereof with the ground can be prevented.

Moreover, if the extended state of the right boom 61 and the left boom 62 by the right-boom sensor 85 and the left-boom sensor 86 is detected, and if at least either one of the right-boom sensor 85 and the left-boom sensor 86 is in the OFF state, the first shut-off valve 83 and the second shut-off valve 84 are switched to the shut-off positions. As a result, the fact that at least either one of the right boom 61 and the left boom 62 is not at the working position can be detected more reliably, and the rotational movement of the boom 6 can be braked.

Moreover, if the right boom 61 is extended to the direction to be arranged on an extension of the roll base 5, the right-boom sensor 85 detects that the right boom 61 is at the working position, and if the left boom 62 is extended to the direction to be arranged on the extension of the roll base 5, the left-boom sensor 86 detects that the left boom 62 is at the working position. As a result, the fact that the right boom 61 and the left boom 62 are at the working position can be detected with accuracy, respectively, and thus, unintentional rotational movement of the boom 6 in the roll direction can be prevented more reliably.

Moreover, the first shut-off valve 83 and the second shut-off valve 84 are shut-off valves capable of being switched between the communication position where the first passage 79 and the second passage 80 are allowed to communicate and the shut-off position where the first passage 79 is shut off, and the second passage 80 is also shut off, and the controller 87 subjects the first shut-off valve 83 and the second shut-off valve 84 to switching control on the basis of the detection signals from the right-boom sensor 85 and the left-boom sensor 86. As a result, even if the right and left weight balance of the boom 6 is lost since at least either one of the right boom 61 and the left boom 62 is folded by the operation of the operator, the rotational movement of the boom 6 is automatically braked, and breakage of the boom 6 can be prevented.

Embodiments of the present invention were described above, but the above embodiments are merely examples of applications of the present invention, and the technical scope of the present invention is not limited to the specific constitutions of the above embodiments.

For example, in the aforementioned embodiment, the electromagnetic directional switching valve 94 is exemplified, but a mechanical directional switching valve whose position is switched on the basis of the lever operation of the operator may be used.

Moreover, it may be so configured that, if a switch capable of performing a turning ON/OFF operation of a roll damper is provided and if the operator performs an ON operation on the switch, the first shut-off valve 83 and the second shut-off valve 84 are switched to the communication positions. In this case, if the switch is subjected to the ON operation and if both the right-boom sensor 85 and the left-boom sensor 86 are in the ON state, it is only necessary that the controller 87 switches the first shut-off valve 83 and the second shut-off valve 84 to the communication positions.

Moreover, in the aforementioned embodiment, a touch sensor is exemplified as the right-boom sensor 85 and the left-boom sensor 86, but other proximity sensor, angle sensor, stroke sensor and the like may be also used.

Moreover, in the aforementioned embodiment, the boom-side bracket 64 has a substantially L-shape and is arranged so as to be brought into contact with the right-boom sensor 85 and the left-boom sensor 86 when the right boom 61 and the left boom 62 are extended in the right-and-left horizontal direction of the working vehicle 1, but by changing the shape or a bending angle of the boom-side bracket 64, a position where the boom-side bracket 64 touches the right-boom sensor 85 and the left-boom sensor 86 (to be brought into the ON state) can be changed.

This application claims priority based on Japanese Patent Application No. 2014-29482 filed with the Japan Patent Office on Feb. 19, 2014, the entire contents of which are incorporated into this specification.

1. A boom damping device for suppressing vibration of a boom capable of rotational movement in a roll direction of a working vehicle, the boom having a right boom expanded in a right direction of the working vehicle and a left boom expanded in a left direction of the working vehicle, comprising:
a fluid pressure cylinder connected between the working vehicle and the boom, the fluid pressure cylinder being configured to perform an expansion/contraction operation in conjunction with rotational movement of the boom in the roll direction of the working vehicle;
a first pressure accumulator configured to pressurize one chamber of the fluid pressure cylinder and into/out of which an operating fluid flows through a first passage with the expansion/contraction operation of the fluid pressure cylinder;
a second pressure accumulator configured to pressurize the other chamber of the fluid pressure cylinder and into/out of which the operating fluid flows through a second passage with the expansion/contraction operation of the fluid pressure cylinder; and
a shut-off switch configured to shut off the first passage and configured to shut off the second passage if at least either one of the right boom and the left boom is not at a working position expanded in a right-and-left direction of the working vehicle.

2. The boom damping device according to claim 1, further comprising:
a right-boom detector configured to detect whether or not the right boom is at the working position; and
a left-boom detector configured to detect whether or not the left boom is at the working position, wherein
the shut-off switch shuts off the first passage and shuts off the second passage if it is detected that at least either one of the right boom and the left boom is not at the working position.

3. The boom damping device according to claim 2, wherein
the boom further has a center boom pivotally supported by the working vehicle and having both ends to which the right boom and the left boom are connected;
the right-boom detector detects that the right boom is at the working position if the right boom is expanded to a direction to be arranged on an extension of the center boom; and
the left-boom detector detects that the left boom is at the working position if the left boom is expanded to a direction to be arranged on the extension of the center boom.

4. The boom damping device according to claim 2, wherein
the shut-off switch is a shut-off valve capable of switching between a communication position where the first passage is allowed to communicate and the second passage is allowed to communicate and a shut-off position where the first passage is shut off and the second passage is shut off; and
the boom damping device further comprises a control part configured to subject the shut-off valve to switching control between the communication position and the shut-off position on the basis of detection signals of the right-boom detector and the left-boom detector.

5. A spraying device for spraying a control liquid provided with the boom damping device according to claim 1.
